(19) United States
(12) Patent Application Publication
(10) Pub. No.: US 2015/0321460 A1
(43) Pub. Date: Nov. 12, 2015

(54) METHOD FOR PRODUCING A RAISED SEAM

(71) Applicant: Ford Global Technologies, LLC, Dearborn, MI (US)

(72) Inventors: Jörg Saßmannshausen, Leverkusen (DE); Joerg Frietsch, Hennef (DE)

(21) Appl. No.: 14/425,990

(22) PCT Filed: Sep. 4, 2013
(86) PCT No.: PCT/EP2013/068280

§ 371 Date: Mar. 4, 2015

(30) Foreign Application Priority Data
Sep. 5, 2012 (DE) 10 2012 215 715.8
Oct. 1, 2012 (DE) 10 2012 217 960.7

(51) Int. Cl. B32B 38/00; B32B 37/18; B32B 37/06; B32B 37/12

(52) U.S. Cl. CPC B32B 38/0012; B32B 37/1292; B32B 37/18; B32B 37/06; B32B 38/0036; B32B 2038/0076; B32B 2605/08

(57) ABSTRACT

The invention relates to a method for producing a double-flanged seam (1) between an inner component (2) having a wing flange (4) and an outer component (3) having a fold flange (7), comprising at least the following steps:

applying an adhesive strip (8) in cold condition to the front edge (12) of the wing flange (4),
heating up the adhesive strip (8),
gluing the adhesive strip (8) on to one side or both sides of the wing flange (4),
applying the inner component (2) to the outer component (3),
crimping over the fold flange (7) toward the inner component (2), and
heating up at least the double-flanged seam region to cure the adhesive strip (8).

The present invention relates to a method for producing a double-flanged seam between an inner component having a wing flange and an outer component having a fold flange.

DE 10 2008 060 930 A1 is concerned with a combined folded and adhesive joint on a body part of a motor vehicle, wherein an outer part of the body part is folded in a peripheral region about a peripheral region of an inner part of the body part, wherein an adhesive surrounds the peripheral region of the inner part on both sides. The production of the folded and adhesive joint is intended to be simplified if the adhesive is formed by a strip adhesive which can be shaped at least during the production of the folded and adhesive joint.

Double-flanged seams, which can also be referred to as folded seams, are used for connecting an inner panel to an outer panel. The two components here are designed to be connected to each other by bending the fold flange on the outer panel around a free edge section, the wing flange, of the inner component. However, it is difficult to protect the double-flanged seam from corrosive exposure since moisture can accumulate in the folded seam, i.e. moisture permanently remaining in the fold gap, the moisture having an accelerating effect on the corrosive process. Also, it is known that, in the event of a merely frictional metal on metal contact, the double-flanged seam does not have the necessary strength properties, required, for example, in vehicle manufacturing. Double-flanged seams are used, for example, on hoods, doors or the like. It is known therefore to provide the fold gap with suitable means in order to avoid the formation of corrosion and in order to be able to make the joint more resistant as a whole.

For this purpose, use is made, for example, of adhesives, as disclosed, for example, in WO 94/21740. WO 91/21740 is based on a method for achieving an adhesive joint in a folded seam between an inner part and an outer part using a cold epoxy adhesive applied to the surface of the edge region of the outer part, which surface is in contact with the edge region of the inner part. The two parts are brought one onto the other, with the fold flange being bent over. After the folded seam is completed, the adhesive strip is applied and pressed around the joint, but the adhesive does not cover the entire double-flanged seam. Therefore, an air bubble may be trapped in the double-flanged seam, this being intended to be prevented by the teaching of WO 94/21740 by an adhesive strip being applied in a hot phase before the two components are brought together and also before the folding. Air bubbles can therefore probably be avoided. However, the hot and liquid adhesive is pressed out of the folded seam during the folding-over operation, and therefore the adhesive can form drops which, when they drip off, may result in soiling of the assembly line and of the tools in the following assembly stations.

In order to avoid such soiling, provision is intended to be made for the adhesive to cure before further processing of the component. However, this has a disadvantageous effect on the production cycle and is also complicated and unprofitable from an industrial management aspect.

EP 0 892 180 A1 proposes surrounding the inner component, around the free edge section thereof, with a preshaped adhesive body. The adhesive body is of U-shaped design in such a manner that it is kept attached to the free edge section by clamping force. A double-sided adhesive strip can optionally also be applied to the longer of the two U limbs such that an adhesive force can act in addition to the clamping force. If the adhesive body is fitted, the components are brought together, with the double-flanged seam being completed by bending over the fold flange. The adhesive body is then softened such that the components are wetted at the point of adhesion. The point of adhesion is then cured.

DE 36 21 758 discloses a method for sealing a folded joint by means of a double-flanged seam adhesive, which is gellable and/or curable by a supply of heat, in the fold gap and by means of a sealing layer which is connected upstream of said fold gap, consists of a material which is gellable and/or curable by a supply of heat, and is applied to the cut edge of the folded joint, wherein the folded joint is subjected to at least one heat treatment. At least the double-flanged seam is heated to the curing temperature, with the sealing layer being applied to the heated cut edge.

Accordingly, the production of a double-flanged seam with a pasty adhesive is a critical process in respect of corrosion protection, but also in respect of the filling, as intended, of the double-flanged seam by means of the adhesive. In addition, provision is made for the adhesive to be subject to preliminary curing, with individual weld points also being provided in order to prevent a relative movement of the two components to be connected. Up until now, a filling rate of 100/100/>0 can be achieved only by squeezing the adhesive out of the double-flanged seam, and this involves a considerable outlay on cleaning, as already indicated above with regard to WO 94/21740. The joint can be inspected by an inspection similar to a statistical process control (SPC), but non-destructive inspection methods for verifying whether the double-flanged seam is correctly filled are still not adequately used.

Against this background, the present invention has been set the object of specifying a method for producing a double-flanged seam, with which it can be ensured that the double-flanged seam is protected against corrosion, wherein inadvertent trapping of air can be eliminated and wherein the use of an additional edge sealing can be dispensed with.

This object is achieved by a method with the features of claim 1. The dependent claims disclose further, particularly advantageous refinements of the invention.

It should be emphasized that the features cited individually in the description below can be combined with one another in any technically expedient manner and indicate further refinements of the invention.

The description characterizes and specifies the invention, in particular, additionally in conjunction with the figures.

According to the invention, a method for producing a double-flanged seam between an inner component having a wing flange and an outer component having a fold flange comprises at least the following steps:
applying an adhesive strip in cold condition to the front edge of the wing flange,
heating up the adhesive strip,
gluing the adhesive strip on to one side or both sides of the wing flange,
applying the inner component to the outer component,
crimping over the fold flange toward the inner component, and
heating up at least the double-flanged seam region to cure the adhesive strip.

In the case of double-flanged seams of the type in question, adhesive is required on both sides of the wing flange. For this purpose, the adhesive strip is applied to the end side of the wing flange, wherein the adhesive strip is in the cold or slightly preheated condition, i.e. has little stickiness or low tack and is also relatively stiff. The adhesive strip is only of a flexibility and stickiness such that it can be applied to the front edge and does not slip there. However, such an adhesive strip cannot bend in both directions around the front edge of the wing flange. By heating following the application, the adhesive strip becomes sticky and remains stuck to the front edge. At the same time, it becomes soft and can be glued to both sides of the wing flange. Customarily, the application and heating take place in directly consecutive working steps by, for example, an application head applying the adhesive strip and said application head also having suitable heating means.

During the heating, the adhesive strip should be heated only to an extent such that it does not cure or the curing process starts. The heating is intended to take place only to such an extent as to make the adhesive strip sticky and soft so that the latter can be glued to the wing flange, which generally does not have a rectilinear profile. This method enables an adhesive strip which can be difficult to handle to be securely applied to a curved wing flange.

The adhesive strip is advantageously placed from above onto the front edge. As a result, the adhesive strip can buckle over downward under the effect of gravitational force on the right and left of the front edge during heating.

The adhesive strip can be heated by any suitable heat source, for example infrared or laser light. Use is preferably made of hot air, through one or more nozzles.

The heated adhesive strip is preferably glued by means of air jets which press the adhesive strip on one or both sides against the wing flange. The increased stickiness or increased tack of the heated adhesive strip means that the latter easily remains glued to the wing flange.

Particularly preferably, hot air serves for heating and gluing the adhesive strip. The heating and gluing can therefore take place in one working step. Hot air nozzles which press the adhesive strip against the wing flange by means of one hot air jet or a plurality of hot air jets are suitable for this purpose. The heated adhesive strip immediately remains stuck there.

In an advantageous manner, the front edge of the wing flange is predominantly horizontal during the application and/or gluing of the adhesive strip and/or the wing flange is predominantly vertical, as seen in the transverse direction, during the application and/or gluing of the adhesive strip. If the adhesive strip is placed onto the front edge from above, said adhesive strip can already buckle away downward under gravitational force in a uniform manner on the right and left of the front edge upon heating and can thus be glued uniformly to the wing flange.

The components are advantageously treated with a protective coating after crimping over and before heating the double-flanged seam. All of the regions which are not covered by the adhesive strip are then painted. In particular if the glue of the adhesive strip expands during heating, the glue of the adhesive strip will expand over the coating and thus ensures improved protection against corrosion

A fold gap is preferably formed between wing flange and fold flange, and the adhesive strip, at least in sections, has an extent which, at least at one end of the fold gap, is shorter than the extent of the fold gap. This reliably ensures that the components in the fold gap are painted prior to curing, as a result of which the fold gap is well protected against corrosion following the curing and expansion of the adhesive.

Further advantageous details and effects of the invention are explained in more detail below with reference to exemplary embodiments which are illustrated in the figures, in which:

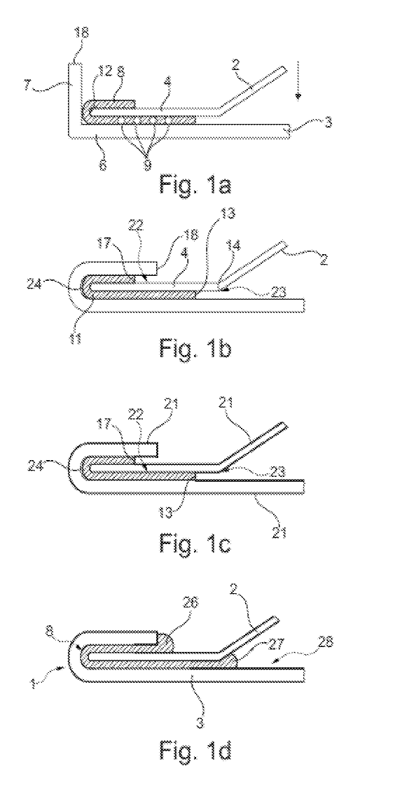

FIGS. 1a to 1d show a schematic sectional view with individual steps for producing a double-flanged seam, and

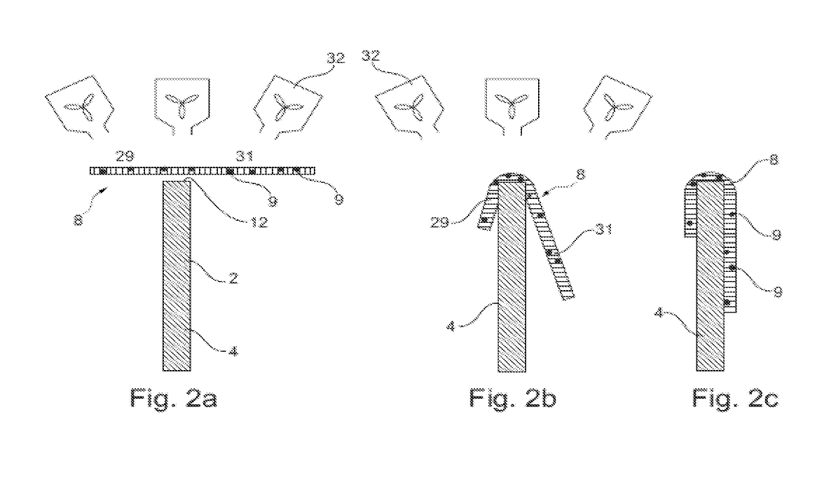

FIGS. 2a to 2c show an exemplary procedure for applying the structural adhesive strip to one of the components.

The same parts are always provided with the same reference numbers in the various figures, and therefore said parts will generally also only be described once.

FIGS. 1a to 1d show a method for producing a double-flanged seam 1 between an inner component 2 and an outer component 3. The inner component 2 is, for example, an inside door panel of a motor vehicle and has a wing flange 4 which, by way of example, is arranged at an angle to the inner component 2. The outer component 3 is, for example, an outside door panel of the motor vehicle and has a fold flange 7 arranged on an edge section 6.

First of all, an adhesive strip 8 is applied. The adhesive strip 8 is produced with such an extent that the adhesive strip 8 is shorter than a fold gap 11 (FIG. 1b). The adhesive strip 8 therefore has a width which is shorter, i.e. narrower, than the extent of the entire fold gap 11. The adhesive strip 8 has spacers 9 which are illustrated schematically in FIG. 1a. The spacers 9 will be discussed in more detail further below.

The adhesive strip 8 is applied in such a manner that it surrounds a front edge 12 of the inner component 2 such that the adhesive strip 8 is guided around the inner component 2 with an extent which is shorter than the fold gap 11. The fold flange 7 is subsequently folded toward the inner component 2 (FIG. 1b). The fold flange 7 here can be directly and completely crimped over, but a preliminary folding-over of, for example, 45° of the fold flange 7 toward the inner component 2 is also conceivable, and the complete crimping-over is continued only after a possible visual inspection.

The previous steps have been carried out without the effect of heat, wherein it can be seen in FIG. 1b that the adhesive strip 8 is shorter in the cold state, i.e. is narrower, than the fold gap 11. The adhesive strip 8 here is arranged with the inner, free edge 13 thereof within the fold gap 11 and is spaced apart from a transition 14 of the wing flange 4 of the inner component 2, i.e. at an angle between the two. The outer, free edge 17 of the adhesive strip 8, which edge is opposite the inner edge 13, likewise resides within the fold gap 11, but spaced apart from the free edge 18 of the fold flange 7. An expansion space 22 and 23 is thereby formed in each case.

If the adhesive strip 8 is supplied under the effect of heat without the adhesive strip 8 expanding, the latter is first of all cooled before the fold flange 7 is crimped over.

If the fold flange 7 is folded, i.e. the state according to FIG. 1b is reached, a paint coating 21 is applied (FIG. 1c). The paint coating 21 is preferably applied in such a manner that not only the region of the double-flanged seam 1, but also adjacent regions of the two components 2 and 3, are provided with the paint coating 21. The two components 2 and 3 are preferably completely provided with the paint coating 21, which is expedient if the latter is designed as a corrosion protection primer.

As can be seen in FIG. 1c, the paint coating 21 is likewise applied in the expansion spaces 22 and 23 of the fold gap 11 and is also applied to the edges 13 and 17 of the adhesive strip 8. The adhesive strip 8 is thus housed, as it were, by the paint coating 21.

If the paint coating 21 is applied, at least the region of the double-flanged seam is subjected to a heat treatment, i.e. is heated up. A heat treatment to be carried out in an electric furnace at, for example, 175° C. for a duration of, for example, 10 minutes, may be sufficient here for the adhesive strip 8 to be able to expand out of the fold gap 11 into the respective expansion spaces 22 and 23, but also in all other directions. For example, an air gap 24 which is filled after the heat treatment (FIG. 1d) can be seen in FIG. 1c. Of course, the values mentioned are mentioned merely by way of example and are in no way limiting.

FIG. 1d shows the state after the heat treatment. FIG. 1d shows that the adhesive strip 8, inter alia, has emerged from the fold gap 11 and in each case a sealing bead 26, 27 is formed, said sealing bead settling firstly around the free edge 18 of the fold flange 7 and secondly into the intermediate space 28 between the inner component 2 and the outer component 3, thereby bridging the transition 14 of the free edge section 4 of the inner component 2 and sealing the two components. In this respect, after heating, a filling rate of at least 100/100/>0, in particular also of critical regions, such as, for example, corners, rounded portions and also design lines, can be achieved. Since the adhesive strip 8 does not initially completely fill the fold gap 11, but is arranged with the free edges 13 and 17 thereof merely at a small distance from the elements 14 and 18 concerned, even a filling rate of 100/100/100 can be seen in the figures after the expansion.

However, it can also be seen in FIG. 1d that the respective sealing bead 26, 27 also encases the paint coating 21 in the regions concerned.

By the paint coating 21 also being surrounded by the expanded adhesive strip 8, a particularly targeted sealing against penetrating moisture is ensured.

The adhesive strip 8 can be, for example, a hot-melt sealing tape which is adhesive on one side and is made from an acrylate-epoxy hybrid adhesive.

All of the steps can be carried out in an automated manner, for example, by means of a robot. In a preferred embodiment, strips of in each case adaptable length of the adhesive strip 8 are cut to size and applied to one of the two components 2, or in the manner described above. The aim here is that the adhesive strip 8 in the cold condition has the width which is adapted in each case to the anticipated fold gap 11, and therefore the expansion space 22 and 23 is in each case formed, with it being possible for the adhesive strip to have a thickness of 0.3 to 1 mm.

As already mentioned above, the adhesive strip can have finely dispersed spacers 9, particularly in the form of glass beads. The spacers 9 can define a defined spacing between the two body parts 2, 3 and therefore the two components 2, 3 in particular after the crimping, are at a homogeneous distance at least in the region of the fold gap 11. A homogeneous distance between the two components 2, 3 can be considered to be advantageous to the effect that the fold gap 11 can likewise be filled homogeneously. In this respect, provision can expediently be made for the spacers 9 to have dimensions within the range of the width of the fold gap. The spacers 9 can have different geometrical configurations, wherein the spacers 9 in one adhesive strip preferably are intended to have the same geometrical configuration. Such spacers 9 can be designed, for example, as tetrahedrons, as spheres, as cubes or as octahedrons, in order to mention just a few non-limiting configurations. Of course, the dimensions of the spacers 9 are variable, but preferably directly dependent on the double-flanged seam 1 to be produced. In particular, the spacers 9 can ensure a minimum volume in order to achieve a controlled expansion of the adhesive strip 8. Of course, the material of the spacers 9 is also not restricted to the material glass. By way of example, the spacers 9 can also consist of a ceramic or of raw mineral materials. The geometrical spacers 9 thus also serve for ensuring uniform flange geometries after the folding-over operation.

FIGS. 2a to 2c illustrate a possible procedure as to how the adhesive strip is placed around the free edge section 4 of the inner component 2. The adhesive strip 8 is designed by way of example as a hot-melt sealing tape which is adhesive on both sides.

The adhesive strip 8 is placed onto the front side 12 of the free edge section 4, wherein the adhesive strip 8 is deformed by the protruding limbs 29 and 31 thereof, i.e. by the excess length 29 thereof and by the fastening section 31 thereof toward the wing flange 4 such that an adhesive strip 8 surrounding wing flange 4 in some regions adheres to the wing flange 4. In order to deform the adhesive strip 8 toward the wing flange 4, hot air nozzles 32 can be provided, by way of example. The hot air heats up the adhesive strip 8 at such a low temperature that deformation is possible, but expansion is prevented. If the adhesive strip 8 is placed around the free edge section 4 (FIG. 2c), the adhesive strip 8 is cooled, wherein cooling to room temperature is sufficient. The spacers 9, which may have entirely different dimensions, as can be seen in FIG. 2a to FIG. 2c, can be seen in the adhesive strip 8.

List of reference numbers:

| | |
|---|---|
| 1 | Double-flanged seam |
| 2 | Inner component |
| 3 | Outer component |
| 4 | Wing flange of 2 |
| 6 | Edge section of 3 |
| 7 | Fold flange |
| 8 | Adhesive strip |
| 9 | Spacer |
| 11 | Fold gap |
| 12 | Front edge of 4 |
| 13 | Inner free edge of 8 |
| 14 | Transition |
| 17 | Outer free edge of 8 |
| 18 | Free edge of 7 |
| 21 | Paint coating |
| 22 | Expansion space |
| 23 | Expansion space |
| 24 | Air gap |
| 26 | Sealing bead |
| 27 | Sealing bead |
| 28 | Intermediate space |
| 29 | Excess length |
| 31 | Fastening section |
| 32 | Hot air nozzles |

1. A method for producing a double-flanged seam between an inner component having a wing flange and an outer component having a fold flange, comprising at least the following steps:
applying an adhesive strip to the front edge of the wing flange,
heating up the adhesive strip,
gluing the adhesive strip on to one side or both sides of the wing flange,
applying the inner component to the outer component,
crimping over the fold flange toward the inner component, and
heating up at least the double-flanged seam region to cure the adhesive strip.

2. The method as claimed in claim 1,
characterized in that
the adhesive strip is applied from above to the front edge of the wing flange.

3. The method as claimed in claim 1, characterized in that the front edge of the wing flange is predominantly horizontal during the application and/or gluing of the adhesive strip.

4. The method as claimed in claim 1,
characterized in that
the wing flange is predominantly vertical, as seen in the transverse direction, during the application and/or gluing of the adhesive strip.

5. The method as claimed in claim 1,
characterized in that
the adhesive strip is applied in the cold condition to the front edge of the wing flange.

6. The method as claimed in claim 1,
characterized in that
the adhesive strip is preheated before being applied to the front edge of the wing flange.

7. The method as claimed in claim 1,
characterized in that
the adhesive strip is blasted with hot air for heating purposes.

8. The method as claimed in claim 1,
characterized in that
the adhesive strip is subjected to an air jet or to a plurality of air jets for gluing purposes.

9. The method as claimed in claim 1,
characterized in that
the adhesive strip is blasted with hot air for heating and gluing purposes.

10. The method as claimed in claim 1,
characterized in that
the adhesive strip is glued under gravitational force.

11. The method as claimed in claim 1,
characterized in that
the components are treated with a protective coating after crimping over and before heating the double-flanged seam.

12. The method as claimed in claim 1,
characterized in that
the glue of the adhesive strip expands during heating.

13. The method as claimed in claim 1,
characterized in that
a fold gap is formed between wing flange and fold flange, and the adhesive strip, at least in sections, has an extent which, at least at one end of the fold gap, is shorter than the extent of the fold gap.
